(19) United States
(12) Patent Application Publication
(10) Pub. No.: US 2010/0034194 A1
(43) Pub. Date: Feb. 11, 2010

(54) Eliminating unreachable subscribers in voice-over-ip networks

(75) Inventors: Geert Fieremans, Boca Raton, FL (US); Nigel Smith, Deerfield Beach, FL (US); Robert S. Stockdale, Lake Worth, FL (US)

Correspondence Address: STAAS & HALSEY LLP, SUITE 700, 1201 NEW YORK AVENUE, N.W., WASHINGTON, DC, 20005, US

(73) Assignee: SIEMENS COMMUNICATIONS INC., BOCA RATON, FL (US)

(21) Appl. No.: 12/311,438

(22) PCT Filed: Oct. 1, 2007
(86) PCT No.: PCT/US2007/021011

§ 371 Date: Mar. 30, 2009

Related U.S. Application Data
(60) Provisional application No. 60/850,775, filed on Oct. 11, 2006.

(51) Int. Cl. H04L 12/66

(52) U.S. Cl. 370/352

(57) ABSTRACT

A method detects an unreachable endpoint in a voice over IP network operating according to standard protocol. The endpoints include a first endpoint as a call originator and a second endpoint as a VoIP destination. The endpoints are connectable via a soft-switch. After each call, a check is performed to determine whether the second endpoint responded to the call. If the second endpoint did not respond to the call, a non-call related message found in the standard protocol is sent from the soft-switch to the second endpoint. If the second endpoint does not respond to the non-call related message, the second endpoint is deactivated so that further calls are not

### CROSS-REFERENCE TO RELATED APPLICATIONS

This application is related to and claims priority to U.S. Provisional application entitled Method for Faster Detection of Unreachable Subscribers having Ser. No. 60/848,185 by Stockdale et al., filed Sep. 29, 2006, incorporated by reference herein.

The present invention relates to a method of faster detection of unreachable subscribers, in particular, unreachable VoIP endpoints, according to widely used protocol standards.

There are three types of VoIP service currently available. One type of VoIP makes use of ATAs (Analog Telephone Adapter) which take the analog signal from a traditional phone and convert it into digital data for communication over the Internet. Secondly, some certain phones are IP phones, or phones that have an appearance similar to a traditional phone, but instead of having a typical RJ-11 connector, an IP phone has a RJ-45 Ethernet connector. Thirdly, VoIP service is available utilizing a piece of software that makes use of your computer connected to the Internet, a headset, and speakers.

Telephones have made use of switches for call routing since the 1870s. Switches have advanced from being operated by humans, to automatic operation, to emulation through software known as a softswitch. VoIP networks typically make use of softswitches, which map phone numbers to IP addresses for call routing. One such type of softswitch is known as a, Private Branch Exchange (“PBX”) or SIP server/registrar in SIP (Session Initial Protocol).

VoIP telephones have come to function and interface with telephones in a manner extremely similar to landline phones that operate over public switched telephone networks (PSTN) or plain old telephone service networks (POTS). However, one of the shortcomings of Voice Over Internet Protocol telephony and its related protocols such as SIP (Session Initiation Protocol) and MGCP (Media Gateway Control Protocol) is the inability to adapt to failures in network endpoints. Both protocols are documented in detail by the Internet Engineering Task Force (IETF). Both SIP and MGCP protocols are published in Request for Comment (REC) text files freely available on the Internet for the information and knowledge of the community. The description of the SIP protocol can be found in RFC 3261. (RFC 3261 available at http://www.ietf.org/rfc/rfc3261.txt). The description of the MGCP protocol can be found in RFC 3435. (RFC 3435, available at http://www.ietf.org/rfc/rfc3435.txt).

When a SIP telephone endpoint is removed, either accidentally or otherwise, e.g. a laptop with a VoIP software client connected to a wireless Internet connection ventures too far from a wireless router, or a PC connected to a wired Internet connection removes an Ethernet cable prior to properly terminating a VoIP software client, the SIP endpoint remains registered and mapped in the SIP server/registrar from a particular IP address to a telephone number. The endpoint remains registered even though the endpoint is removed from the network and no longer reachable.

This endpoint can be registered but unreachable for up to one hour. During this hour, calls are still routed to the removed endpoint. The caller, after dialing, experiences dead air for up to thirty-two seconds according to standard protocol before being rerouted to voicemail, for example. The caller will likely give up and hang up prior to thirty-two seconds. If the caller or any subsequent caller attempts to make another call inside the one hour window, they are presented with the same thirty-two second delay problem.

The presently known solutions either (1) rely upon the caller to not hang up for approximately thirty two seconds before being routed to voicemail or (2) shorten the thirty-two second time interval, which is a default time interval based upon protocol standards, thus violating the protocol.

### SUMMARY

It is one possible object to provide a faster method for detecting unreachable endpoints in a VoIP network and marking these unreachable endpoints unavailable using only standard components and messages.

It is another possible object to provide a method for detecting unreachable SIP (Session Initiation Protocol) endpoints, marking the endpoints unavailable and removing them from the SIP server according to SIP protocol.

It is still another possible object to provide a method for detecting unreachable MGCP/NCS (Media Gateway Control Protocol)/(Network Call Signaling) endpoints and marking the endpoints unavailable according to the MGCP protocol.

The inventors propose a method for detecting an unreachable endpoint in a voice over IP network operating according to standard protocol. The endpoints include a first endpoint as a call originator and a second endpoint as a VoIP destination. The endpoints are connectable via a soft-switch. After each call, a check is performed to determine whether the second endpoint responded to the call. This may be done by doing a state check in the soft-switch. The state check may indicate whether the second endpoint returned a message indicating that the second endpoint is ringing or returned a message indicating that the second endpoint has been answered, ringing has stopped and conversation can begin. If the second endpoint did not respond to the call, a non-call related message found in the standard protocol is sent from the soft-switch to the second endpoint. The standard protocol specifies that the non-call related message is used to test endpoints without causing the second endpoint to ring or interrupting a conversation in progress with the second endpoint. The non-call related message is resent if the second endpoint does not respond to a first transmission of the non-call related message. The non-call related message is resent until the second endpoint responds or until a maximum number of resends is reached. The second endpoint is marked as unreachable if the second endpoint does not respond to the non-call related message and resending the non-call related message is completed. The second endpoint is deactivated at a soft-switch if the second endpoint is marked as unreachable, the second endpoint being deactivated so that further calls are not routed to the second endpoint. When the second endpoint when the second endpoint is reconnected, the second endpoint is reactivated.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a schematic drawing illustrating a voice over IP telephone connected to a network;

FIG. 2 is a message flow diagram illustrating a successful call to a SIP endpoint in the SIP protocol;

FIG. 3 is a message flow diagram illustrating an unsuccessful call to a SIP endpoint in the SIP protocol;

FIG. 4 is a message flow diagram illustrating removal of an unresponsive SIP endpoint in the SIP protocol;

FIG. 5 is a message flow diagram illustrating a successful call to a MGCP/NCS endpoint in the MGCP/NCS protocol;

FIG. 6 is a message flow diagram illustrating an unsuccessful call to a MGCP/NCS endpoint in the MGCP/NCS protocol; and

FIG. 7 is a message flow diagram illustrating marking an unresponsive MGCP/NCS endpoint as unavailable in MGCP/NCS protocol.

### DETAILED DESCRIPTION OF THE EMBODIMENTS

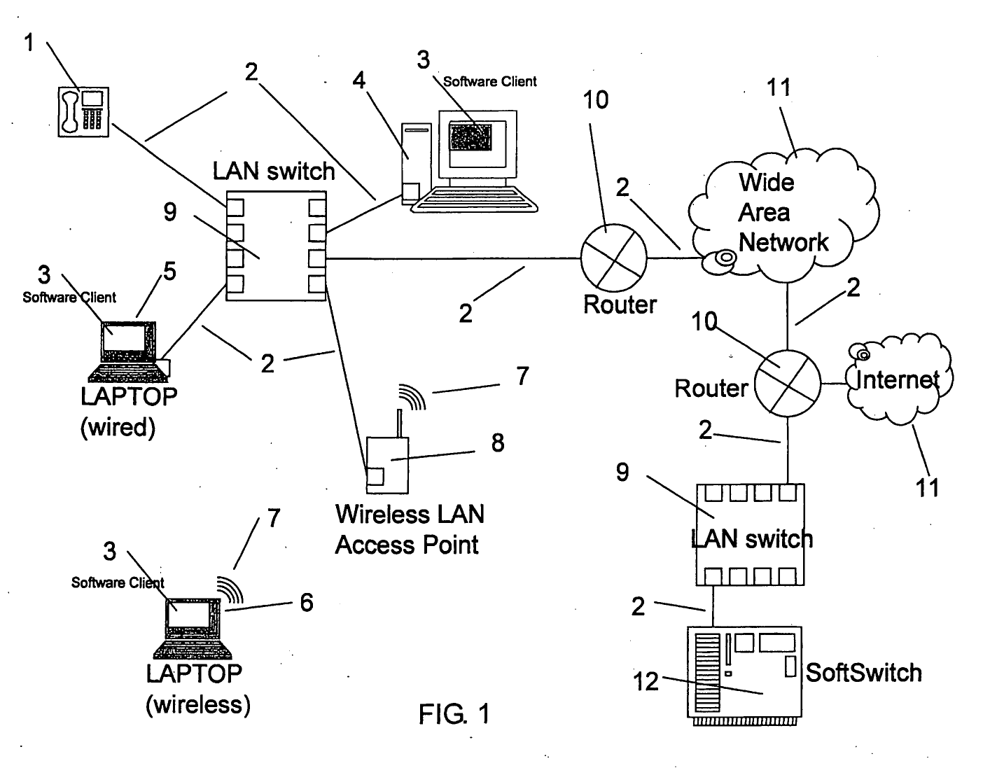

As depicted in FIG. 1, typical VoIP subscribers may have a VoIP enabled telephone 1, a network connection 2, a software client 3 running, and possibly a PC 4. Unavailability of a VoIP endpoint can occur due to failure related to either the telephone 1, network connection 2, software client 3, PC 4, etc. The PC 4 is connected to a softswitch 12 which is possibly connected to Internet 6.

Failure can occur, if the network connection 2 abruptly fails, or PC 4 connected to a wireless Internet connection wanders too far from a wireless access point such that it can no longer sustain an Internet connection. Failure can occur due a power outage or due to a crash of the PC 4 or a crash of the software client 3. Failure can occur if the telephone 1, is unplugged from the network connection 2, before terminating the software client 3, properly. Failure can occur if there is a problem somewhere in the WAN, wide area network, between two endpoints in the WAN. Finally, failure can occur if the softswitch 12, fails to receive a deregister message, which is typically sent by the software client 3 upon proper termination of the software client 3.

When any of these failures occur, telephone calls continue to be routed from other telephones, through the softswitch 12, to the VoIP telephone 1, which can no longer be reached. The other calling telephones will not be able to leave a voicemail for the VoIP telephone 1, without waiting through thirty-two seconds of dead air. The calling telephones may give up before that time.

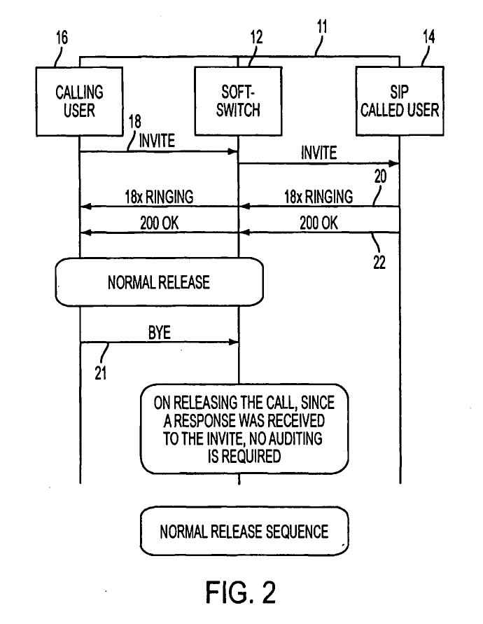

The inventors propose a method and apparatus that detects unavailable voice over IP endpoints, marks those endpoints unavailable, and deactivates those endpoints. A telephone call to a voice over IP telephone, as depicted in FIG. 2, requires a network 11, over which voice telephone calls may be transported between two endpoints. The network 11 typically has a softswitch 12, to route calls between a voice over IP endpoint 14, and other telephones 16.

FIG. 2 illustrates a successful telephone call in SIP, or Session Initiation Protocol, a protocol used for voice over IP telephone calls. Another calling telephone, which can be either a voice over IP telephone or POTS telephone 16 calls a receiving SIP endpoint 14. Calling telephone 16 sends an Invite Message 18 that gets routed to the softswitch 12. The softswitch 12 reroutes the Invite message 18 to the SIP endpoint 14. The Invite Message 18 is typically received by the SIP endpoint 14 in under 0.5 seconds. Typically very quickly, also in under 0.5 seconds, the responsive SIP endpoint 14 returns a 18× ringing message 20 to the softswitch 12 which notifies the softswitch 12 that the endpoint 14 is responsive and ringing. The softswitch 12 then routes the 18× ringing message 20 to the calling telephone 16. If the receiving SIP endpoint 14 answers the call, a 200 OK message 22 is sent back from the endpoint 14 to the softswitch 12, which then reroutes the 200 OK message 22 to the calling telephone 16. The 200 OK message 22 is sent when a successful call is established. A Bye message 21 is sent by the calling telephone 16 when the telephone is hung up. The Bye message 21 terminates the telephone call. As is illustrated in FIG. 2, since a response was received to the Invite message 18, no auditing of the SIP endpoint 14 is required.

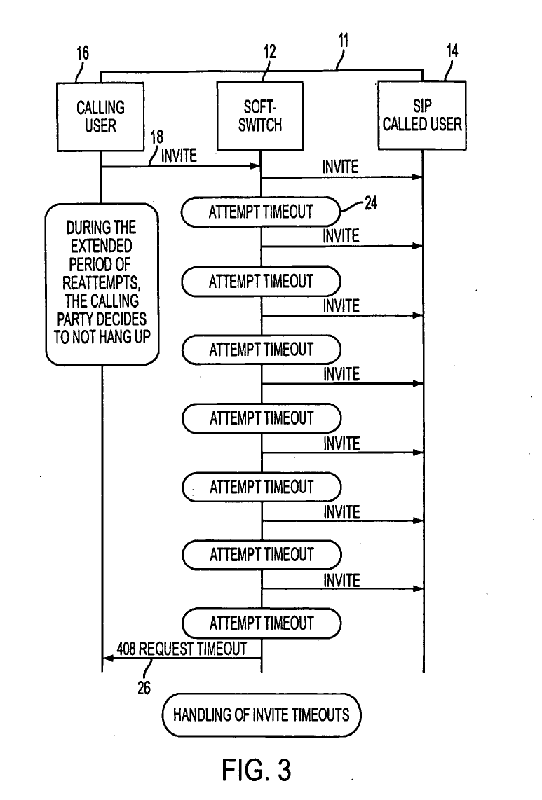

FIG. 3 illustrates an unsuccessful telephone call in the SIP protocol. The calling telephone 16 calls the receiving SIP endpoint 14. This endpoint 14, although registered with the softswitch 12 has been improperly disconnected or suffered a failure as described above. Thus the endpoint 14 cannot be reached even though it is still registered with the softswitch 12. However, when the calling telephone 16 calls the endpoint 14, the Invite message 18 is sent from the calling telephone 16 to the softswitch 12 which still believes the endpoint 14 is reachable. The softswitch 12 reroutes the Invite message 18 to the unreachable endpoint 14 which fails to return with the 18× ringing message 20 or 200 OK message 22.

According to the SIP protocol, the softswitch 12 will wait 0.5 seconds until an Attempt Timeout 24 occurs, at which time softswitch 12 will resend the Invite message 18 to the endpoint 14. According to SIP protocol, this sequence of sending the Invite message 18 followed by the Attempt Timeout 24 will continue at doubled time intervals including at 1 second, 2 seconds, 4 seconds, 8 seconds and 16 seconds. The total waiting time is therefore 0.5 seconds plus 1 second plus 2 seconds plus 4 seconds plus 8 seconds plus 16 seconds which is approximately equal to 32 seconds of wait time.

However, the calling telephone user 16 will experience dead air without any ring tone during the above sequence which lasts up to approximately 32 seconds. At this point, if the calling telephone 16 user is waiting and has not hung up, the calling telephone 16 will receive a 408 Request Timeout message 26 from the softswitch 12 and the calling telephone 16 user will be routed to voicemail to leave a voicemail for the SIP endpoint 14. However, it is of course possible that the calling telephone 16 user will hang up and not wait 32 seconds.

During a time period of up to approximately one hour, the SIP endpoint 14 will continue to receive telephone calls routed from the softswitch 12, and each subsequent caller during this hour will experience the 32 second dead air wait.

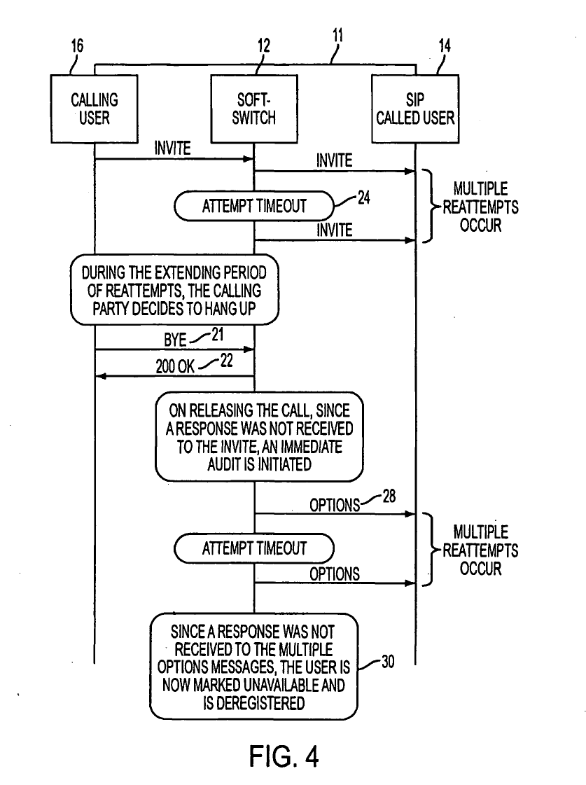

FIG. 4 illustrates unsuccessful telephone call handling in the SIP protocol with the proposed method and apparatus to eliminate the 32 second dead air wait after a first failed telephone call. A calling telephone 16 either waits to leave a voicemail, or hangs up prior to the end of the timeout sequence. If the calling telephone 16 hangs up, it sends a Bye message 21 to the softswitch 12, which then sends a 200 OK message 22 to the calling telephone 16.

According to the proposed method and apparatus, after each call at least first check is performed during the call. The first check is an internal audit to determine whether the endpoint responded normally. In this case of FIG. 4, the first check, the audit, will show that a response was not received by the softswitch 12 from the SIP endpoint 14. In this case the softswitch 12 performs a second check to determine if the SIP endpoint is truly unreachable or if a temporary problem in the network occurred. As is illustrated in FIG. 4, the softswitch 12 sends an Options Message 28 to the SIP endpoint 14. The Options message 28 is a standard SIP message. The Options Message 28 is a non-call related message, thus it does not cause a telephone to ring if it is received. The Options message 28 is typically used for testing the capabilities of the endpoint to which it is sent and a typical response from the endpoint is a 200 OK message 22, as described on pages 66-67 of RFC 3261.

As described above, according to SIP protocol, the Options Message 28 is sent to the SIP endpoint 14 in the same manner as the Invite message 18. That is, the Options Message 28 is resent after increasingly longer intervels if no response is received. If no response is received at the end of 32 seconds, it is assumed that the endpoint 14 is not reachable. At this point, the SIP endpoint 14 will be deregistered and deactivated by sending an Unregister message 30, to the softswitch 12. The Unregister message 30 is also a standard message SIP. The Unregister message 30, is typically sent by the software client 3 in the event of a proper software client termination for example, when a person logs off his/her PC-based VoIP account. By using the Unregister message, as proposed here, only one caller will experience dead air problems when calling an improperly removed SIP endpoint. After the endpoint is deregistered and deactivated, future callers are quickly routed to voicemail, typically in under 5. seconds.

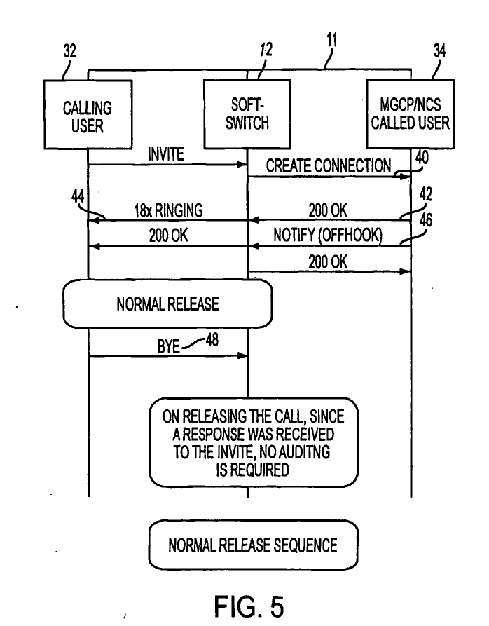

The present invention is also adaptable to the MGCP/NCS protocol (Media Gateway Control Protocol). FIG. 5 illustrates a successful telephone call according to the MGCP/NCS protocol which is similar to a successful call in SIP. When a calling user, using a voice over IP telephone or POTS telephone 32 calls a MGCP endpoint 34, the call is routed through a softswitch 36. When the calling user 32 telephones the MGCP endpoint 34, an Invite Message 38 is sent to the softswitch 36. The softswitch 36 sends a Create Connection Message 40 to the MGCP endpoint 34. The MGCP endpoint 34 responds by sending a 200 OK message 42 to the softswitch 36 which then forwards a 18× Ringing message 44 to the calling user 32. If the MGCP endpoint 34 receives the call and picks up the phone, a Notify (offhook) message 46 is sent to the softswitch 36, which then forwards a 200 OK message 42 to the calling user 32 indicating voice communication can proceed. A 200 OK message 42 is then sent from the softswitch 36 to the MGCP endpoint 34. After normal release of the call, a Bye message 48 is sent from the calling user 32 to the softswitch 36. At the end of every call, the proposed method performs a first check, an audit, to determine if the called user 34 responded properly. Since a response was received from the MGCP endpoint 34 by the softswitch 36 the first check, the immediate audit of the MGCP endpoint 34, will show that the endpoint 34 is operating properly.

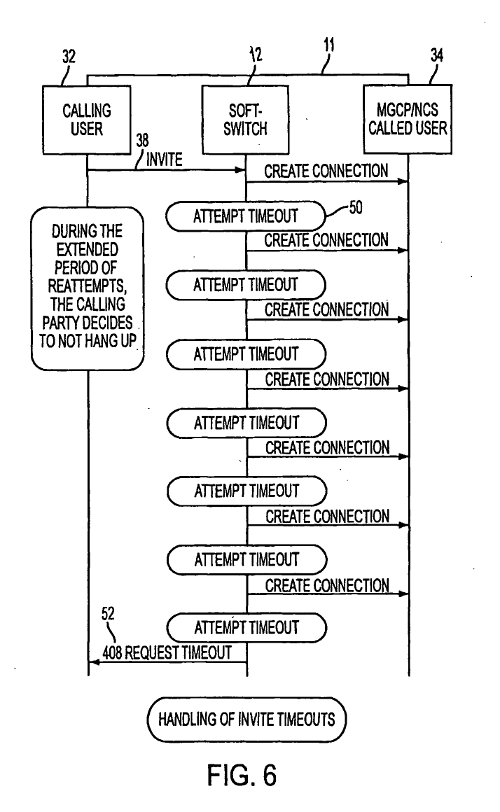

FIG. 6 illustrates an unsuccessful call in the MGCP protocol which is similar to an unsuccessful call in the SIP protocol. The calling telephone 32, which can be either a voice over IP telephone, or POTS telephone 32 dials a call to the MGCP endpoint 34. This endpoint 34, which has been previously established with the softswitch 36 has been improperly disconnected or suffered a failure as described above, thus the endpoint 34 cannot be reached by other telephones. However, when the calling telephone 32 calls the endpoint 34, the Invite message 38 is sent from the calling telephone 32 to the softswitch 36, which still believes the endpoint 34 to be reachable. The softswitch 36 reroutes the Invite message 38, as the Create Connection Message 40 to the MGCP endpoint 34.

According to MGCP protocol, the softswitch 36 will waits approximately 0.5 seconds until an Attempt Timeout 50 occurs, at which time softswitch 36 resends the Create Connection message 40 to the endpoint 34. According to MGCP protocol, this sequence of sending the Create Connection message 40 followed by the Attempt Timeout 50 will continue at doubled time intervals including at 1 second, 2 seconds, 4 seconds, 8 seconds and 16 seconds. The total waiting time is therefore approximately equal to 32 seconds.

The calling telephone 32 user experiences dead air without any ring tone during the above sequence which lasts up to approximately 32 seconds. If the calling telephone 32 is still waiting and has not hung up at the end of 32 seconds, the calling telephone 32 receives a 408 Request Timeout message 52 from the softswitch 36. The calling telephone is then routed to voicemail to leave a voicemail for the MGCP endpoint 34. However, it is possible that the calling telephone 32 user will have terminated the telephone call and given up anytime within thirty-two seconds.

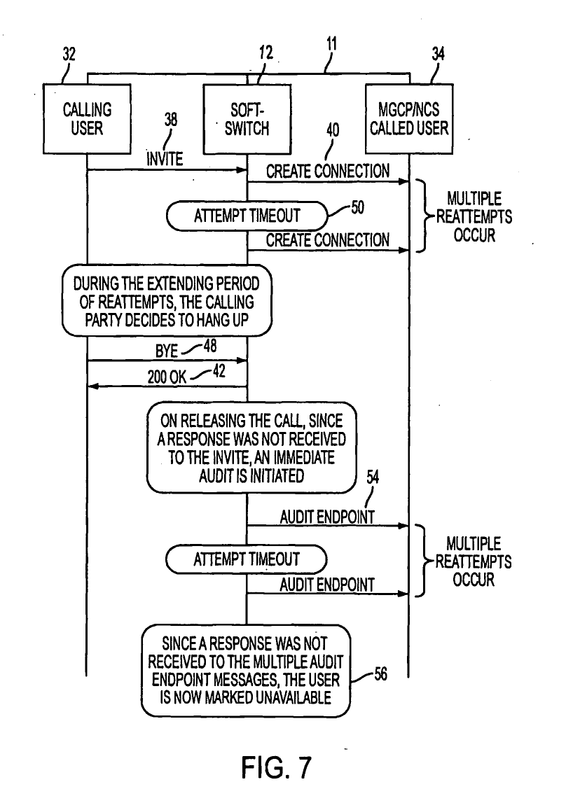

During a time window similar to the one hour window in SIP, but possibly even longer, the MGCP endpoint 34 will continue have telephone calls routed thereto from the softswitch 36 even though the endpoint 34 cannot receive calls. The message flow diagram shown in FIG. 7 does not employ the first and second checks proposed by the inventors. Thus, each subsequent caller thereafter will experience the thirty-two second sequence described above.

FIG. 7 illustrates unsuccessful call handling in the MGCP protocol which is similar to unsuccessful call handing in the SIP protocol, to eliminate the wait after a first failed telephone call to an MGCP endpoint. The calling telephone 32 user either waits to leave a voicemail, or hangs up prior to the end of the thirty-two second timeout sequence. If the calling telephone 32 hangs up, it sends a Bye message 48 to the softswitch 36, which then sends a 200 OK message 42 to the calling telephone 32.

At this point, a first check, the audit, is performed. Since a response was not received by the softswitch 36 from the MGCP endpoint 34, the softswitch 36 knows that there is a potential problem. Therefore, the softswitch 36 performs a second check of the MGCP endpoint to see if the MGCP endpoint is truly unreachable or whether a temporary problem in the network occurred. As is illustrated in FIG. 7, the softswitch 36 sends an Audit Endpoint Message 54 to the MGCP endpoint 34. The Audit Endpoint message 54 is a non-call related message, thus it does not cause a phone to ring if it is received. The Audit Endpoint Message 54 differs slightly from the Options Message 28 in SIP, in that it is a specific function used for testing an endpoint to check for a response, and does not test the capabilities of an endpoint. However, both messages are defined by their respective protocols. A typical response to the Audit Endpoint 34 from a MGCP endpoint is a 200 OK message, as described on page 60 of RFC 3435. Note that it is not possible to simply send out the Audit Endpoint Message at regular intervals to all endpoints, because this would flood a softswitch.

As described in paragraphs 0049-0055, according to MGCP protocol, the Audit Endpoint message 54 is sent to the MGCP endpoint 34 in the same manner as the initial Invite message 38. If no response is received at the end of 32 seconds, it is assumed that the endpoint 34 is not reachable. At this point, the MGCP endpoint 34 will be marked unavailable 56 according to standard MGCP protocol. Thus, only one caller will experience problems when calling an improperly removed MGCP endpoint, and all subsequent callers will be quickly rerouted to voicemail, typically in under 0.5 seconds.

### Reconnection of Removed Endpoints

With the proposed method and apparatus, an endpoint is deactivated if there is a problem with the endpoint. Both improperly removed or disconnected SIP endpoints and MGCP endpoints are easily reconnected and reactivated.

After a SIP endpoint has been unregistered from a SIP server or softswitch, it is easily reregistered. When SIP telephone endpoints are plugged back in, powered up, or the software client is restarted on a PC, the SIP telephone registers with the SIP server or softswitch, thus reactivating the SIP telephone.

MGCP telephones do not necessarily send a message to reactivate when powered up. However, if a telephone call is attempted, MGCP telephones are reactivated. In addition, when a MGCP telephone is marked unavailable as described above, the softswitch periodically audits the endpoint every two minutes to check to see if the endpoint has been reconnected.

The above method of detecting unavailable endpoints can easily be implemented by providing a detection apparatus program stored on a medium such as a flexible disc, CD-ROM, CD-R/W, DVD, Blue-ray, etc.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling with the scope of the invention.

What is claimed is:

1. A method for detecting an unreachable endpoint in a voice over IP network operating according to standard protocol, the endpoints comprising a first endpoint as a call originator and a second endpoint as a VoIP destination, the endpoints being connectable via a soft-switch, comprising:
checking after each call whether the second endpoint responded to the call by doing a state check in the soft-switch, the state check indicating whether the second endpoint returned a message indicating that the second endpoint is ringing or returned a message indicating that the second endpoint has been answered, ringing has stopped and conversation can begin;
sending a non-call related message found in the standard protocol if the second endpoint did not respond to the call, the non-call related message being sent from the soft-switch to the second endpoint, the standard protocol specifying that the non-call related message is used to test endpoints without causing the second endpoint to ring or interrupting a conversation in progress with the second endpoint;
resending the non-call related message if the second endpoint does not respond to a first transmission of the non-call related message, the non-call related message being resent until the second endpoint responds or until a maximum number of resends is reached;
marking the second endpoint as unreachable if the second endpoint does not respond to the non-call related message and resending the non-call related message is completed;
deactivating the second endpoint at a soft-switch if the second endpoint is marked as unreachable, the second endpoint being deactivated so that further calls are not routed to the second endpoint; and
reactivating the second endpoint when the second endpoint is reconnected.

2. A method for detecting an unreachable endpoint in a voice over IP network operating according to standard protocol, the endpoints comprising a first endpoint as a call originator and a second endpoint as a VoIP destination, the endpoints being connectable via a soft-switch, comprising:
checking after each call whether the second endpoint responded to the call;
sending a non-call related message found in the standard protocol if the second endpoint did not respond to the call, the non-call related message being sent from the soft-switch to the second endpoint; and
marking the second endpoint as unreachable if the second endpoint does not respond to the non-call related message.

3. The method according to claim 2, wherein checking whether the second endpoint responded is performed by doing a state check in the soft-switch.

4. The method according to claim 2, wherein checking whether the second endpoint responded is performed by determining whether the second endpoint returned a message indicating that the second endpoint is ringing or returned a message indicating that the second endpoint has been answered, ringing has stopped and conversation can begin.

5. The method according to claim 2, wherein the non-call related message does not cause the second endpoint to ring or interrupt a conversation in progress with the second endpoint.

6. The method according to claim 2, wherein
if the second endpoint does not respond to a first transmission of the non-call related message, the non-call related message is resent until the second endpoint responds or until a maximum number of resends is reached, and
the second endpoint is not marked as unreachable until resending the non-call related message is completed.

7. The method according to claim 2, wherein the standard protocol specifies that the non-call related message is used to test endpoints.

8. The method according to claim 2, further comprising deactivating the second endpoint at a soft-switch if the second endpoint is marked as unreachable, the second endpoint being deactivated so that further calls are not routed to the second endpoint.

9. The method according to claim 8, further comprising reactivating the second endpoint when the second endpoint is reconnected.

10. The method according to claim 8, wherein the standard protocol is SIP and the second endpoint is deregistered to deactivate the second endpoint.

11. The method of claim 8, wherein the standard protocol is MGCP and the second endpoint is marked unavailable to deactivate the second endpoint.

12. A voice over IP soft-switch to detect an unreachable second endpoint in a VoIP network operating according to standard protocol, the second endpoint being a call destination and being connectable to a first endpoint as a call originator through the soft-switch, comprising:
a checking unit to check after each call whether the second endpoint responded to the call from a first endpoint;
a transmitter to send a non-call related message found in the standard protocol if the second endpoint did not respond to the call, the non-call related message being sent from the soft-switch to the second endpoint; and
a marking unit to mark the second endpoint as unreachable if the second endpoint does not respond to the non-call related message.
